(19) United States
(12) Patent Application Publication
(10) Pub. No.: US 2009/0302563 A1
(43) Pub. Date: Dec. 10, 2009

(54) PAINTERS WHEELED CADDY

(76) Inventor: Richard R. Thibault, Shelby Township, MI (US)

Correspondence Address: VAN OPHEM & VANOPHEM, PC;REMY J VANOPHEM, PC, 51543 VAN DYKE, SHELBY TOWNSHIP, MI, 48316-4447, US

(21) Appl. No.: 12/207,583

(22) Filed: Sep. 10, 2008

Related U.S. Application Data
(60) Provisional application No. 61/059,947, filed on Jun. 9, 2008.

(51) Int. Cl. B60P 3/00

(52) U.S. Cl. 280/47.34; 280/727

(57) ABSTRACT

The invention is a paint caddy for performing painting activities adapted for use by a skilled painter. The paint caddy includes a rigid frame having a lower and an upper support member vertically separated by upright corner members. The lower support member extends beyond the upper support member to form a platform area upon which a five gallon paint container can be stored. The upper support member is molded in the form of a paint tray in which an optional liner may be fitted. The lower support member provides compartments for storage of paint tools and accessories. Four caster wheels are appropriately attached to the lower support member so that the paint caddy can be wheeled from a service vehicle to a specific job site having stored therein the painter's tools, as well as taking into account ergonomic considerations for all necessary material supplies to perform daily paint activities.

### CROSS-REFERENCE TO RELATED APPLICATIONS

This application claims the benefit of U.S. Provisional Patent Application Ser. No. 61/059,947 filed on Jun. 9, 2008.

### FEDERALLY SPONSORED RESEARCH OR DEVELOPMENT

Not Applicable.

### REFERENCE TO SEQUENCE LISTING

Not Applicable.

### BACKGROUND OF THE INVENTION

1. Field of the Invention

The invention relates to a service cart for skilled tradesman. More particularly, the invention concerns a wheeled compartmentalized tool hardware supply mobile caddy adapted to increase the convenience of tools and supplies used by a painter. More particularly, the invention is a mobile storage unit useful for transporting and supporting paint buckets, paint supplies such as brushes and rollers, including easy access to an open paint pan so as to facilitate the painting operation by allowing the painter to apply paint at a faster rate without interruptions and shorten the overall time within which a job can be completed.

2. Description of the Related Art

In view of the continuing upwardly spiraling cost of labor associated with service type jobs, it is imperative that tools used by the worker be provided with increased convenience in order to maintain the overall cost of the job within permissible limits. As a result, the use of roller caddies, carts, or carriers for transporting tools to and from the job site have been developed for countless specific objectives and requirements. For example, Keddie, U.S. Pat. No. 4,458,963 discloses a tool caddy stool that is carried by the user and is specifically made for sitting on or for standing on, as well as to store and carry tools so as to keep tools within easy reach during performance, repair, maintenance or construction of various tasks. Bergeron, U.S. Pat. No. 6,698,771 discloses a wheeled caddy for washing a vehicle which consists of a base assembly with a base member mounted on a wheel assembly carrying a support member which includes cleaning accessory holders, as well as a bucket at the top thereof to contain a vehicle washing liquid. Perelli et al., U.S. Pat. No. 6,746,039 teaches a dolly having multiple supports hingedly joined together to carry around containers, either one or two, for collecting trash, fluids or refuge. The joined assembly is capable of flexing between the containers and pulling one container onto a floor with a different elevation and is stable when maneuvering around corners and further provides the ability to rotate one platform with respect to an adjacent platform for storage purposes. Owens, U.S. Pat. No. 5,156,411 discloses a paint pail of a single wall construction having a receptacle with the capacity for holding a gallon or more of paint in which a roller can be quickly, easily, and evenly coated with paint. The curvature of the wall is such that the roller can be worked across it to remove essentially the last drop of paint stored in the receptacle, conserving paint. The walls of the receptacle allow the pail to be stacked with a substantial portion of the receptacle disposed within the receptacle of the pail immediately below it. These modifications save storage and shelf space. The reference further discloses that in a single, unitary piece, of the receptacle and of the wall in which is formed a pair of horizontally spaced holes for detachably mounting an adjustable paint splatter shield on the paint pail, thereby eliminating the need for additional support, such as a caddy, for the paint shield.

Ericson, U.S. Pat. No. 5,727,708 discloses a form-fit disposable liner for a reusable plastic five gallon paint bucket. The liner includes a cylindrically shaped sidewall and a semi-circularly shaped bottom wall that conforms to the sidewall and bottom wall of the bucket. An internal roller landing extends down from a semi-circular shaped top wall of the liner at an angle thereto into a vertically extending planer sidewall. The roller landing includes a series of molded “stair step” ridges that allow a coating product contained in the liner to be effectively rolled into a paint roller. A domed shaped lid seals the liner and allows a conventional paint roller to be stored in the liner when the lid is on.

Finally, Carrelli, U.S. Pat. No. 6,695,325 discloses a mobile paint caddy in the form of a multipurpose cart useful for transporting and supporting paint buckets, paint supplies such as brushes and rollers or an open paint can. In one embodiment of the mobile paint caddy, two pairs of suitable small diameter wheels extend below each end portion of the frame, and two pair of non-swivelable, larger diameter wheels extend below the central portion of the frame. A handle and the pair of larger diameter wheels enable the user to transmit a pivoting force to one end of the frame, whereupon the small diameter wheels adjacent thereto are driven into engagement with the ground and the large diameter wheels at the other end of the frame are lifted out of contact with the ground surface.

Further, the inventor hereof, in currently pending U.S. patent application Ser. No. 11/469,923, filed on Sep. 5, 2006, discloses a wheeled mobile caddy which has many advantages over a wheeled or non-wheeled tool box, rack, or service cart and is particularly useful for tradesmen, repairmen, or home-mechanics. The invention consists of a wheeled support frame wherein the lower support member expands beyond the upper support member to provide a lower platform upon which a conventional cylindrical bucket is mounted. A leather liner is mounted to the bucket, which circumscribes the bucket and drapes downwardly from the upper rim of the bucket. The liner includes a plurality of inner pockets for storing a variety of small tools. The wheeled mobile caddy includes on its lower support member a variety of compartments intended to be used for storage and/or conveyance of power tools generally related to the tradesman's specific trade or work. The upper support member provides a seat for the user, while four wheels mounted to the bottom support member provides the mobility to permit the wheeled mobile caddy to be conveniently moved about the worksite or from the tradesman's vehicle to the worksite.

The efficiency of mobile skilled trade and service personnel has been severely hampered due to problems associated with the transportation of essential tools and material supplies from a van or service vehicle to the point at the job site where they are needed. Although most tradesmen have shelving, drawers, or drawer units within or about the vehicle so as to organize their tools and materials, which permit the tradesman to transport their tools to the job site, once on the job site, the tradesman must physically carry the tools from the vehicle to the actual working area. Also, with respect to a mechanic or especially a home handyman who contemplate doing home repairs, maintenance or construction work on objects in the home or other sites, discover that the project requires some tools and hardware other than what they are able to carry at one time to the work place. The traditional and probably the only suitable response to this situation is to make several trips back and forth to a tool and hardware storage place such as a garage, a basement or a truck parked on the street to get those items which they unexpectedly needed. Such conduct creates fatigue and obviously in terms of a tradesman, adds to the cost of a project as a result of the inefficiency related thereto. Numerous toolboxes, chests, racks and the like have been proposed to utilize for carrying different types of tools. Some workers, especially painters, require easy and convenient access to a limited number of tools but have no convenient way to convey these from their service vehicle to the actual job site. Accordingly, what is needed is a mobile caddy that provides the painter with a convenient way to transport the necessary tools from a service vehicle to a worksite, is ergonomically designed and provides the painter with a mobile caddy to store all of the supporting supplies for easy access during the painting operation.

### BRIEF SUMMARY OF THE INVENTION

The invention is a product designed for mitigating the problems and unpleasantness associated with a painting operation. In particular, the invention is a wheeled tool caddy which has many advantages over a wheeled or non-wheeled toolbox, rack or service cart and is particularly useful for painters, which is not anticipated or rendered obvious or even implied by any of the prior art, either alone or in combination thereof.

The present invention consists of a wheeled support frame having lower and upper support members. The lower support member extends beyond the upper support member sufficiently to provide a platform upon which is located a conventional cylindrically shaped paint bucket or pail.

The wheeled tool caddy further includes on its lower support member a choice of compartments. Smaller compartments at one end of the lower support member to accommodate two aerosol cans, i.e., stain cleaners, spotting primer, cleaning products, etc. The remainder of the lower compartment is intended to be used for storage and/or conveyance of tools and supplies generally related to the painter's work activity. For example, paint rollers, brushes, rags, tarps, paint tape and the like.

The upper support member is molded in the form of a paint tray which is securely, removably mounted to the lower support member by a plurality of upright corner brace members adapted with slotted holes over a threaded stud and secured together with threaded hand knobs. A handle is attached to the upper support member so that the wheeled tool caddy can be conveniently moved about. The handle is mounted on an extended portion of the upper support member so that when released it will hang straight down along the front surface of the lower and upper support members of the wheeled tool caddy. Further, the handle is pivotably attached to the upper member so as to not extend beyond the top portion of the upper support member to assume a stored position when not in use. Four wheels mounted to the bottom support member provide the mobility to allow the wheeled tool caddy to be conveniently moved from a painter's vehicle to the work site as well as to be moved about the room to be painted by the workman. The wheeled tool caddy allows for convenient arrangement and, hence, quick and easy access and restoration of articles that it carries. Most importantly, it increases the probability in that the worker will bring all the tools and painting supplies necessary to do most tasks at the job site in a single trip.

Further, the upper support member can be used to transport tarps, plastic covers to cover windows and doors as well as extension handles to the actual work site where it can be downloaded so that the wheeled tool caddy may be used as a paint tray caddy by the user while performing the work assignment.

The primary object of the present invention is to provide a wheeled tool caddy for use by tradesmen, or homeowners, as a wheeled tool caddy, to convey tools and material supplies to and from the work site. Additionally, it is an object that the wheeled tool caddy may perform as a portable tool holder and material supply holder while providing a tray from which paint can be dispensed onto a paint roller by the user so as to perform work. The combination provides maximum flexibility in use, furnishing significant degrees of freedom of motion and mobility, with the paint supply bucket or vessel being readily accessible and transportable on the wheeled tool caddy. The bucket additionally is readily storable on the wheeled tool caddy and can easily be removed from the wheeled tool caddy.

A further object of the present invention is to provide an improved mobile support for conveniently and reliably retaining a paint tray and paint supply bucket on a mobile caddy, with the combination further providing a convenient means for alternate ways of carrying and transporting tools and material supplies, as well as for storing of same, so as to be accessible and within easy reach of a painter while performing the painting operation. The combination may be employed for carrying hand tools, tarps, plastic covers, and material supplies to and from a job site and for maintaining the tools in an orderly and accessible fashion and permitting their access by the painter while performing his job.

It is a further object of the invention to provide a combination wheeled tool and supply caddy which may be efficiently used by a painter or homeowner.

It is yet a further object of the invention to provide a combination wheeled tool and material supply caddy which is rugged, durable and ideally adapted to store tools of a painter in an orderly fashion.

It is still a further object of the invention to provide a combination wheeled tool and material supply caddy which may be conveniently moved around the room with easy access by a painter throughout the painting operation.

It is yet a further object of the invention to provide a combination wheeled tool and material supply caddy wherein tools are readily accessible to the painter while functioning simultaneously as a paint tray and support.

It is a further object of the invention to provide a combination wheeled tool and material supply caddy which is simple and of sturdy construction, while also being lightweight and easy to transport to a job site.

It is still a further object of the invention to provide a combination tool and material supply caddy for performing the tradesman's tasks and having tools and supplies readily accessible by the user of the wheeled tool caddy.

Other advantages and features of the present invention will become more apparent from the following detailed description when read in conjunction with the accompanying drawings and claims.

### BRIEF DESCRIPTION OF THE DRAWINGS

FIG. 1 is a perspective drawing of the invention in use by a professional painter at a worksite;

FIG. 2 is a perspective representation of the painter's wheeled caddy with a paint tray as well as a paint pail stored thereon so that a ready supply of paint is available to the user at a worksite;

FIG. 3 is a side elevational view of the painter's wheeled caddy with the paint bucket shown in hyphen outline at the rear thereof and the handle in the towing, as well as rest positions in hyphen outline;

FIG. 4 is an end view of the forward end of the painter's wheeled caddy with the handle shown in a raised position;

FIG. 5 is a top view of FIG. 3 with the compartments along the lower support member shown in hidden line;

FIG. 6 is an exploded view of the details of the interface in circle 6 of FIG. 3 between the lower support member and the upper support member mounted thereon;

FIG. 7 is a cross-section of the fastener elements to mount the upper support member to the lower support member;

FIG. 8 is a perspective view of the upper support member or paint tray of the invention including an optional removable liner; and

FIG. 9 is another embodiment of the invention which shows the extension of the lower support member so as to enable the carrying of two paint buckets while at the same time providing a rope at the front thereof to enable the wheeled carrier to be towed without the handle interfering with either paint bucket.

### DETAILED DESCRIPTION OF THE PREFERRED EMBODIMENT

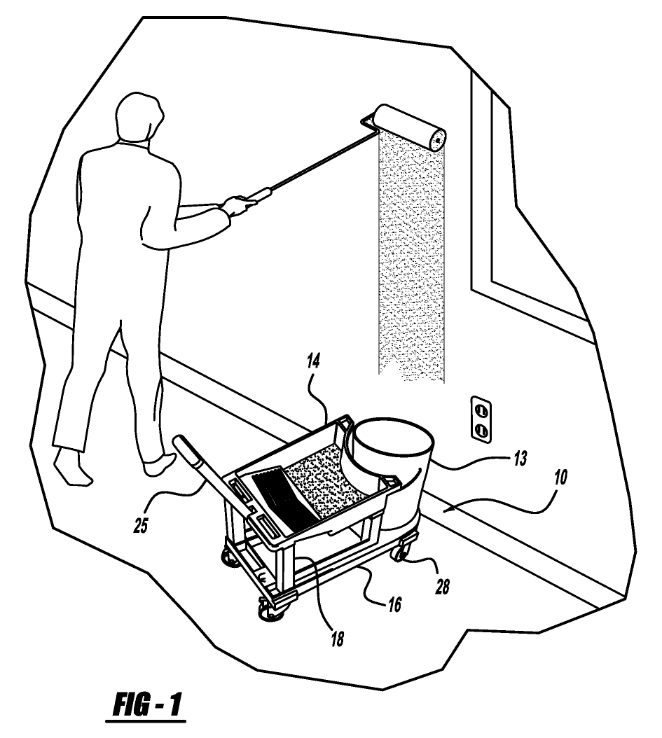

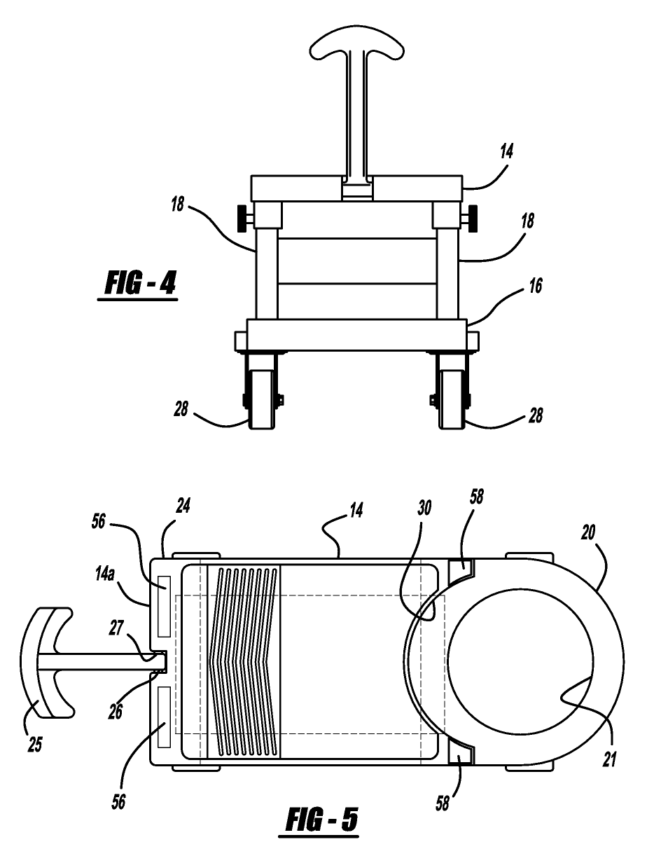

Referring now to the drawings, in particular to FIGS. 1-5, a preferred embodiment of the painter's caddy 10 of the present invention is shown.

The preferred embodiment is equipped with storage areas specifically sized for painter's tools, equipment, and supplies. The painter's caddy as shown generally at 10 includes a support frame 12 which is generally rectangular in shape and adapted to transport one generally cylindrical paint bucket 13. The support frame 12 consists of a molded polymeric material so as to reduce the weight of the overall assembly, and thereby reduce the cost of the assembly to enable the painter's caddy 10 to be configured and marketed for use by professional painters/home handymen and the like. The material selected would be resistant to attack from cleaning fluids and solvents to enable the user to clean the painter's caddy 10 after use. The painter's caddy 10 is a combination vessel/carrier in the form of at least one paint bucket 13, and miscellaneous paint tool storage unit for conveying painting tools and painting supplies to the job site so as to make these readily accessible to the painters to perform their daily work activities. The painter's caddy 10 also provides a relatively flat surface as an upper support member 14 in the form of a paint tray so that a user can stack tarps or plastic covers thereon while conveying material supplies from the service vehicle to the job site.

The support frame 12 has an upper support member 14 in the form of a paint tray, attached to a lower support member 16. The upper support member 14 has four hollow corner posts extending therefrom which mount to the vertical corner uprights 18 proximate the four corners thereof as will be explained in detail hereinafter. The lower support member 16 has at its rearward end a platform 20 extending beyond the rearward end 22 of the upper support member or paint tray 14. A forward end 14a of the upper support member 14 extends beyond the forward end 16a of the lower support member 16 for reasons to be described hereinafter. The forward end 14a of the upper support member 14 has an extended portion 24 whereat, at the center thereof, is pivotally connected a molded handle member 25, for pivotal movement about a transverse horizontal pivot pin 26 mounted across a central cut out 27 in the extended portion 24 of the upper support member 14 of the painter's caddy 10 as is clearly illustrated in FIG. 5. The molded handle member 25 attached about the transverse horizontal pivot pin 26 within the central cutout 27 of the upper support member 14 can pivot without interference with the forward end 14a of the upper support member 14 so that when released by the user, the molded handle member 25 will pivot to hang in a straight down position against the forward end 16a of the lower support member 16 and not extend beyond the top surface of the upper support member 14 and interfere with the paint roller obtaining paint from the paint tray 14, as shown in the hidden lines in FIG. 3. A pivoting axis for the molded handle member 25 is arranged in the extended portion 24 of the upper support member 14 to enable the molded handle member 25, when not in use, to not extend beyond the upper surface of the paint tray 14 as well as rest against the front surface of the forward end 16a portion of the lower support member 16.

Four caster wheels 28 are attached to the lower support member 16 of the support frame 12 proximate the four corners thereof. The caster wheels 28 are alike and have their respective ground engaging surfaces spaced a distance from the bottom end of the support frame 12 so as to be generally co-planar with one another, each caster wheel 28 is adapted to swivel and permit rotational motion, as well as longitudinal movement of the painter's caddy 10. Alternatively, it is conceivable to use a straight through independent axle (not shown) on the rear wheels with only caster wheels 28 at the front of the painter's caddy 10. Such arrangement will permit uni-directional or 360 degree rotation of each front caster wheel 28 structure along the plane of contact with the ground surface. Alternatively, the caster wheels 28 may be mounted on a single axle which runs horizontal to the ground from one side of the painter's caddy 10 to the opposite side thereof. Preferably, however the configuration shown in the figures commonly known as a caster wheel assembly is preferred.

As earlier discussed, the support frame 12 further includes a generally horizontal lower support member 16 which extends rearwardly of the upper support member 14 while also being generally horizontally disposed. In use, the rearward end portion 16b of the platform 20 of the lower support member 16 is intended to provide a platform 20 with a recessed diameter 21 in which is located a conventional cylindrically shaped paint bucket 13 as shown in FIG. 5.

To accommodate the paint bucket 13 on the rearward end 16b of the platform 20 of the lower support member 16, the rearward end 22 of the upper support member 14 is scalloped 30, as shown in FIG. 5, so as to provide a clearance to permit the paint bucket 13 to be seated on the platform 20 on the lower support member 16. It is preferred for the professional painter that the paint bucket 13 is a five gallon bucket so as to have available an ample supply of paint and therefore reduce the number of trips a painter has to make to and from his vehicle to obtain additional supplies or paint to complete the task at hand.

As shown in FIG. 8, the upper support member 14 is molded in the form of a conventional paint tray that can hold approximately 1.5 gallons of paint. The paint tray 14 is provided with a bottom wall 32 including a sloping portion 34 which ends in a steep drop-off portion 36 which in turn merges with the bottom wall portion 32. The side walls 40 and rear side wall 42 form a rectangular container or receptacle. The sloping portion 34 is provided with a series of transversely, parallel spaced inclined ribs 44 to serve the purpose of engaging the paint roller and pressing excess paint from the roller after the roller has been dipped into the pool of paint of the container as is well known in the art. These inclined ribs 44 may also serve to frictionally engage the roller, and retain the roller in the shallow portion of the upper support member 14 when the roller is not in use. The adjoining edges between the bottom wall 32 and three side walls 40, 42 are generously curved to allow the paint to drain to the lowest area of the upper support member 14 as it is used. The uppermost end 46 of the upper support member 14 is molded with a reinforcing rib 47 around its periphery to give the upper support member 14 structural integrity when mounted to the lower support member 16 or removed therefrom for cleaning purposes. Optionally, the user may choose to use an optional paint tray liner 15, as is known to one skilled in the art. Upon completion of the paint job this liner can be discarded and the upper support member 14 remains clean and need only a light water spray to clean same. The rear side wall 42 is scalloped 30 to avoid interfering with the five gallon paint bucket 13 that is placed on the platform 20 as earlier disclosed.

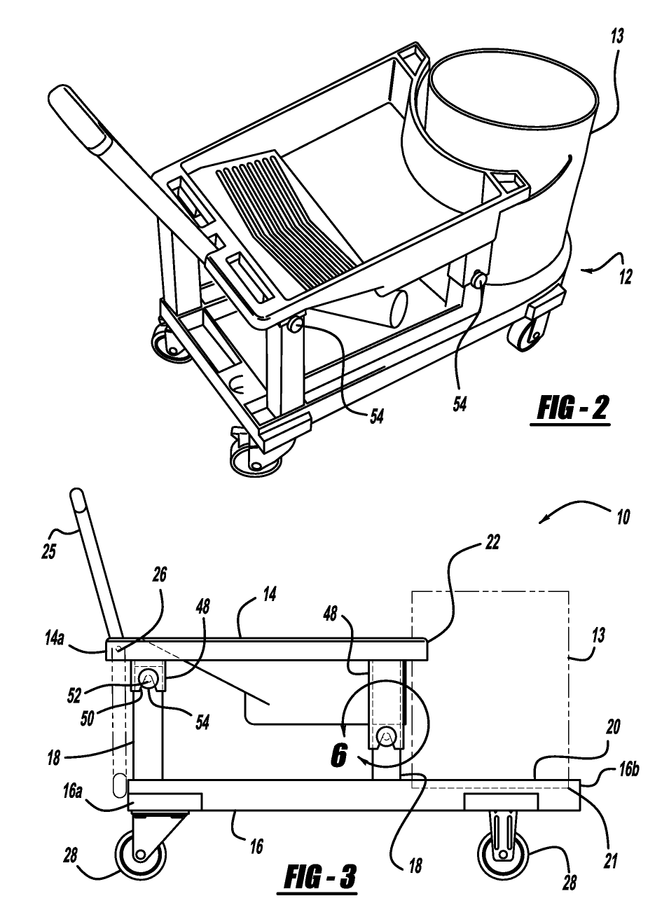

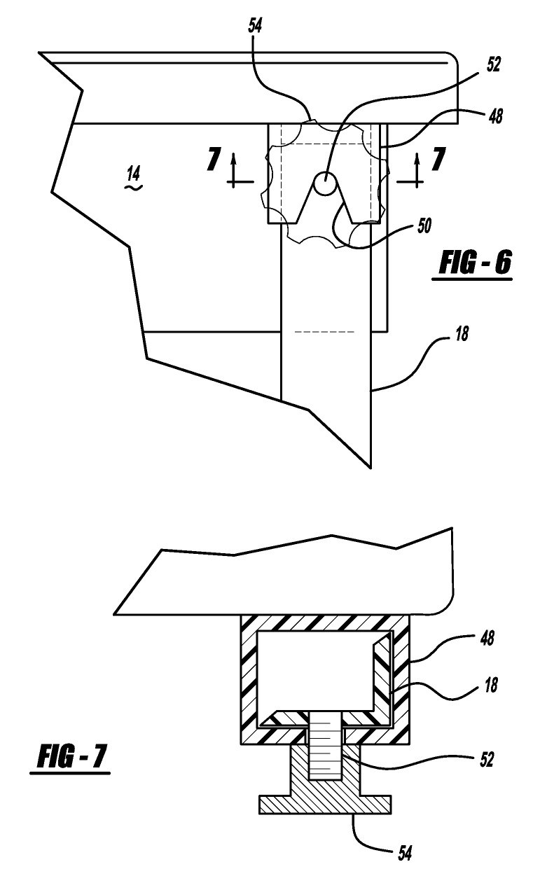

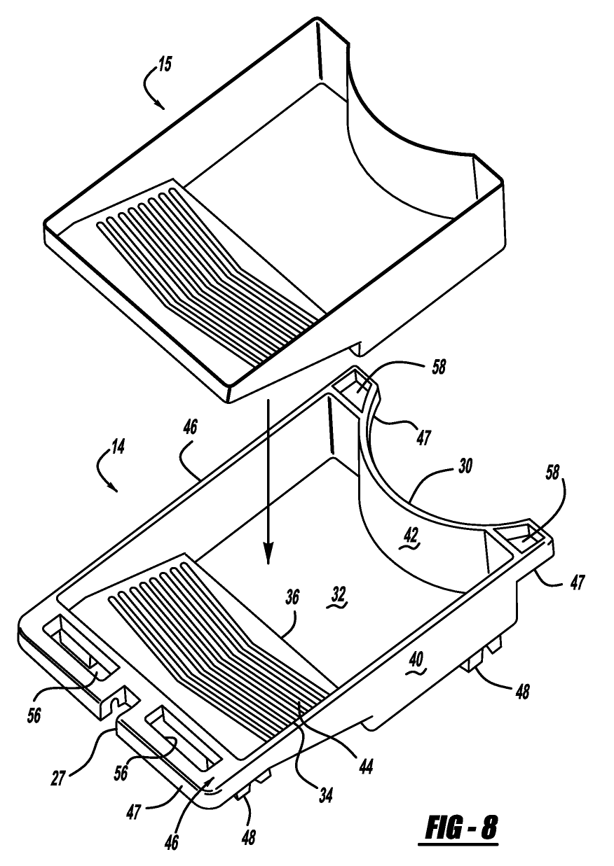

The paint tray 14 is removably mounted to the lower support member 16 by providing at the four corners of the paint tray 14 a hollow post 48 as shown in FIGS. 2, 3, and 6, which interfaces with a respective vertical corner upright 18 to mount the upper support member or paint tray 14 to the lower support member 16. This is accomplished as shown in FIGS. 3 and 6, by providing a vertical tapered slot 50 in each of the four hollow posts 48 and securely mounting or molding in a threaded shoulder bolt 52 permanently to each of the vertical corner uprights 18 along an outer face so as to be transversely extending in a direction away from the longitudinal orientation of both the upper and lower support members 14, 16. The threaded shoulder bolt 52 is mounted at the same height for both forward (nearest to the handle) vertical corner uprights 18 and at a lower position for the rear vertical corner uprights 18 where the height of the paint tray 14 is significantly greater so that the rear vertical corner uprights 18 are much shorter than the front vertical uprights 18. The paint tray 14 is assembled to the vertical corner uprights 18 by lowering the hollow posts 48 over its respective vertical corner upright 18 until the bottom of the vertical tapered slot 50 comes into contact with the threaded diameter of each threaded shoulder bolt 52. Since each threaded shoulder bolt 52 has been selectively placed to be received within the tapered vertical slot 50 of the paint tray 14, the paint tray 14 will be perfectly level when the bottom of the vertical tapered slot 50 bottoms out on the outer threaded diameter of the threaded shoulder bolt 52. A hand knob 54, as shown in FIG. 7, having a central threaded passage therein is now screwed onto each of the ends of the threaded shoulder bolt 52 and tightened to securely fix the paint tray 14 to the vertical corner uprights 18 and in turn to the lower support member 16. The upper support member 14 as disclosed herein has an extended portion 24 with a central cutout 27 wherein a molded handle member is mounted as clearly illustrated in FIG. 3. Further, within the extended portion 24 are provided two slots 56, as shown in FIG. 5, one on either side of the central cutout 27. The purpose of these slots 56 is to use as handles when the upper support member 14 is removed from the lower support member 16 as for example to wash or clean the paint tray 14. The rearward end 22 of the paint tray 14 also has openings 58, as shown in FIG. 5, on either side of the scalloped portion 30 of the rear wall 42 for a similar purpose as well as to be used for purposes of storing tools, i.e. paint roller handles or other supplies which adapt to these openings 58 in the reinforcing rib 47 in the form of a semi-circular peripheral curled edge along the uppermost end 46 of the paint tray 14 also assists in providing rigidity to the paint tray 14 when it is removed from the vertical corner uprights 18.

The painter's caddy 10 further includes on its lower support member 16 a variety of compartments, the smaller of which are located along the forward end 16a of the lower support member 16. Aerosol spray cans can be stored in an upright position. Such spray cans could contain cleaning products, spot cleaner, stain cleaners, primers or degreasers. The larger compartment as shown in dash lines in FIG. 5 is intended to be used for storage and/or conveyance of tools generally related to the painter's specific activity. For example, paint rollers, brushes, rags, masking tape, scrapers, spackling, compound, etc.

As recited hereinabove, the arrangement of the present invention consists of a wheeled caddy to enable carrying the type of tools and material supplies used by a painter in the performance of his daily work functions. Further, the invention contemplates ergonomic factors and providing sufficient storage capacity for the material supplies and tools needed in conjunction with the painter's daily work activities. Such is facilitated by the use of a wheel caddy having a paint bucket located on a platform of the lower support member, which is also adapted to accommodate a variety of conventional painter's tools or supplies by the painter.

From the foregoing, it will be seen that the invention is one well adapted to obtain all the objects herein set forth, together with other advantages which are obvious and which are inherent to the structure.

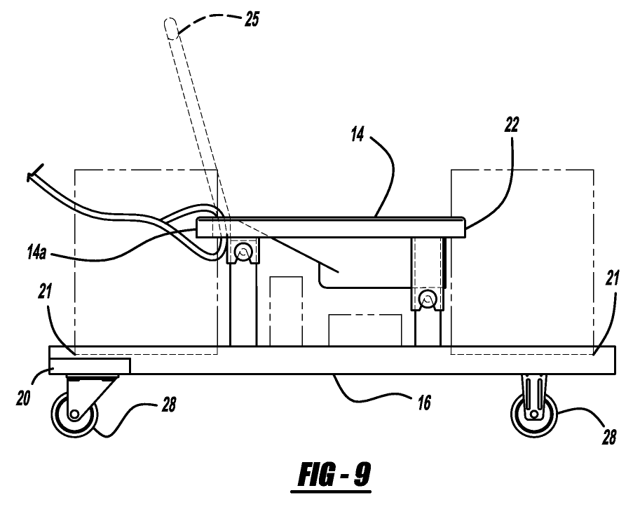

It will be understood that certain features and sub-combinations are of utility and may be employed without reference to other features and sub-combinations. This is contemplated by and well within the scope of the claims. Although only a preferred embodiment and one variant have been shown in the drawings, many other embodiments may be made of the invention without departing from the scope thereof. For example, the wheeled tool caddy could be lengthened in the longitudinal direction by increasing the length of the platform with an added set of caster wheels so that a second paint bucket can be provided on the platform as shown in FIG. 9. This would allow the use of the molded handle member with a two bucket wheeled tool caddy. It is to be understood that all matter herein set forth shown in the accompanying drawings is to be interpreted as illustrated and not in a limiting sense.

What is claimed is:

1. A paint caddy comprising:
a support frame member having
an upper support member; and
a lower support member;
means for supporting said support frame member for rolling movement on a ground surface, said support means mounted to said lower support member;
tool and equipment supplies storage means mounted to said support frame member, said tool and equipment storage means further comprising:
upright support means mounted between said upper support member and lower support member so as to create a space between said upper support member and said lower support member;
platform means attached to said lower support member and extending beyond said upper support member;
storage compartment means mounted to said lower support member beneath said upper support member for providing storage for at least one of said tool and equipment supplies; and
a paint container removably secured to said platform means; and
means for containing paint to be spread by a paint roller complementary with said upper support member whereby a painter may store painting tools and painting supplies to perform a specified painting activity and store said paint tools in one of said storage compartment means located on said support frame member for easy access, while painting, to complete a specified painting activity without undue effort having all necessary painting tools stored on said paint caddy.

2. The paint caddy as claimed in claim 1, wherein said upright support means further comprises at least two upright support members mounted between said upper and lower support members at opposing ends of said upper support member.

3. The paint caddy as claimed in claim 1, wherein said platform means further comprises a platform member extending beyond said upper support member and integral with said lower support member.

4. The paint caddy as claimed in claim 1, wherein said means for supporting said support frame member further comprises a plurality of wheels dispersed underneath said lower support member for conveying said support frame on a ground surface.

5. The paint caddy as claimed in claim 1, further comprising a centrally disposed handle removably attached to said upper support number for easily conveying said paint caddy on a ground surface.

6. The paint caddy as claimed in claim 1, wherein said upright support means further comprises a plurality of upright support members mounted between said upper support member and said lower support member whereby said upper and lower support members are spaced a predetermined distance apart.

7. A paint caddy comprising:
a support frame member having
a lower support member having a forward end and an opposite rearward end;
an upper support member having a forward end and an opposite rearward end; and
one of said forward end and opposite rearward end of said lower support member having a support portion extending beyond said respective one of said forward end and opposite rearward end of said upper support member;
means for mounting said upper support member in spaced relation at a location above said lower support member, said upper support member having a means for containing paint to be spread by a paint roller thereon;
said support portion of said lower support member, having means for supporting a paint container thereon; and
means for supporting said support frame for rolling movement on a ground surface whereby a painter may collect the necessary tools and supplies to perform a specified paint activity and store said tools and/or supplies on said support frame member for easy access during said specified paint activity undue effort having all necessary painting tools stored on said paint caddy.

8. The paint caddy as claimed in claim 7, wherein said means for mounting further comprises at least two upright support members mounted between said upper and lower support members at opposing ends of said upper support member.

9. The paint caddy as claimed in claim 7, wherein said means for supporting a paint container further comprises a platform extending beyond said upper support member and integral with said support portion of said lower support member.

10. The paint caddy as claimed in claim 7, wherein said means for supporting said support frame member further comprises a plurality of wheels dispersed underneath said lower support member for conveying said support frame member on a ground surface.

11. The paint caddy as claimed in claim 7, further comprising a centrally disposed handle removably attached to said upper support member for easily conveying said paint caddy on a ground surface.

12. The paint caddy as claimed in claim 7, wherein said means for mounting further comprises a plurality of upright support members mounted between said upper support member and said lower support member whereby said upper and lower support members are spaced a predetermined distance apart.

13. A paint caddy comprising:
a support frame member having
an upper support member; and
a lower support member;
means for supporting said support frame member for rolling movement on a ground surface, said support means mounted to said lower support member;
means for removably securing a paint container to said lower support member of said frame member;
means for containing paint to be spread by a paint roller complementary with said upper support member;
storage compartment means mounted to said lower support member; and
paint container means mounted to said lower support member whereby a painter may store the necessary paint tools and paint supplies to perform a specified paint activity and store said paint tools in said storage compartment means on said support frame member for easy access, while painting so as to complete said specified paint activity without undue effort having all necessary painting tools and supplies stored on said paint caddy.

14. The paint caddy as claimed in claim 13, further comprising:
means for mounting said upper support member to said lower support member, said means for mounting further comprises at least two upright support members mounted between said upper and said lower support members at opposing ends of said upper support member.

15. The paint caddy as claimed in claim 13, wherein said means for removably securing a paint container further comprises a platform extending beyond said upper support member and integral with said lower support member.

16. The paint caddy as claimed in claim 13, wherein said means for supporting said support frame member further comprises a plurality of wheels dispersed underneath said lower support member for conveying said frame member on a ground surface.

17. The paint caddy as claimed in claim 13, further comprising a centrally disposed handle removably attached to said upper support member for easily conveying said wheeled caddy on a ground surface.

18. The paint caddy as claimed in claim 13, further comprising means for mounting said upper support member to said lower support member said means for mounting comprising a plurality of upright support members mounted between said upper support member and said lower support member whereby said upper and said lower support members are spaced a predetermined distance apart.
